(19) United States
(12) Patent Application Publication
(10) Pub. No.: US 2024/0288158 A1
(43) Pub. Date: Aug. 29, 2024

(54) WALL FOR A FLUIDIZED BED BOILER AND A FLUIDIZED BED BOILER

(71) Applicant: Valmet Technologies Oy, Espoo (FI)

(72) Inventors: Pekka LEHTONEN, Tampere (FI); Tero LUOMAHARJU, Tampere (FI); Pasi YLI-HEMMINKI, Tampere (FI)

(21) Appl. No.: 18/436,728

(22) Filed: Feb. 8, 2024

(30) Foreign Application Priority Data
Feb. 28, 2023 (FI) 20235246

(51) Int. Cl. F23C 10/12; F22B 31/00; F22B 37/10

(52) U.S. Cl. CPC F23C 10/12; F22B 31/0023; F22B 37/108

(57) ABSTRACT

A wall (200) for a fluidized bed boiler (300). The wall (200) comprises a first heat exchanger pipe (110) comprising a first primary portion (111) and a first secondary portion (112), and a second heat exchanger pipe (120) comprising a second primary portion (121) and a second secondary portion (122). A first gap (221) is arranged between the first secondary portion (112) and the second secondary portion (122), and at least a part of the first secondary portion (112) and at least a part of the second secondary portion (122) extend straight, in parallel, and within an imaginable plane (P). The wall (200) is configured such that particulate material is able to propagate through the first gap (221) from a first side (S1) of the plane (P) to the opposite second side (S2) of the plane (P). The wall (200) comprises a refractory (230) arranged on at least one side of a part of the first secondary portion (112) and a part of the second secondary portion (122). A fluidized bed boiler comprising the wall (200).

### TECHNICAL FIELD

The invention relates to fluidized bed boilers. The invention relates to walls of fluidized bed boilers. The invention relates to division walls of fluidized bed boilers.

### BACKGROUND

In fluidized bed boilers, bed material, which typically includes sand, is in fluidized state. Typically walls of the fluidized bed boiler comprise heat exchanger pipes limiting the furnace to recover heat from the furnace. The heat exchanger pipes are connected to each other with fins or similar connectors to form a gas-tight wall structure. As a result of the fluidizing, typically in the furnace near the walls of the boiler the bed material flows downwards. If the wall comprises protrusions or bends, the flowing bed material may easily erode the heat exchanger pipes. It is known e.g. from WO2018/158497 that in such a solution, the erosion of the heat exchanger pipes can be reduced by providing the heat exchanger pipes with a circumferentially extending metal coating. A thickness of the coating, and a diameter of the coated part of the pipe, is selected such that a diameter of the coated part is at most equal a diameter of an uncoated part. Fins are continuously welded to such heat exchanger pipes to form the wall. Part of such a wall may be covered with refractory.

It has been realized that near the interface of the refractory and the heat exchanger pipes, the refractory interferes the flow of the bed material, which, as discussed above, takes place near the walls. Thus, the downwards flowing bed material coincides a surface of the refractory, which interferes the bed material flow. It has been found that near the refractory, highly localized erosion takes place. Unless maintained, such erosion may cause small apertures or holes to the heat exchanger pipes, and thus malfunction of the whole boiler. A size of these holes or apertures may be e.g. in the range of e.g. 5-20 mm by 5-20 mm.

There is thus a need to reduce the erosion of heat exchanger pipes of such a wall structure in particular near the refractory.

### SUMMARY

Without being bound to theory, the inventors consider that the highly localized erosion is a result of a vortex of the bed material being formed near the interface of the refractory and the heat exchanger pipe of the wall. The formation of the vortex is depicted as a comparative example in FIGS. 9a and 9b. In typical use, the direction towards the reader in FIG. 9a is upwards vertical (denoted by Sz in FIG. 9b). Thus, the downwards flowing bed material, flowing along the wall formed by the pipes, when hitting the surface of the refractory, forms vortexes near the refractory, on the side of the furnace, as shown in FIGS. 9a and 9b. It seems that these vortexes can be responsible of highly localized erosion of the heat exchanger pipes of the wall. As a result, the holes or apertures, as discussed above, may erode to the pipes.

The inventors have found that such erosion of heat exchanger pipes can be reduced by (i) increasing the size of the vortex or (ii) by forming such a wall structure that does not generate such vortexes. In line with this finding, when the wall does not comprise the fin near the interface between the refractory and the heat exchanger pipes, the bed material and gases can propagate deeper in between the heat exchanger tubes, thereby providing substantially more space for the vortex. Such a wall structure is disclosed in more specific terms in the independent claim 1.

Moreover, the inventors have found that the vortex-induced erosion of heat exchanger pipes of such a wall structure can be reduced by reducing the tendency of forming any vortexes. In line with this finding, when the wall does not comprise the fin near the interface between the refractory and the heat exchanger pipes, and furthermore the bed material and gases can propagate through the wall to another side of the wall, the tendency of forming any vortexes becomes reduced. Such a wall structure is disclosed in more specific terms in the dependent claim 2.

Other preferable embodiments of the wall are disclosed in the dependent claims 7 to 14.

The wall is preferably a wall of a circulating fluidized bed boiler, as detailed in claims 3 to 6 and 15. The wall is preferably a division wall of a furnace of a circulating fluidized bed boiler, as detailed in claims 3 to 6.

These and other embodiments are further explained in the description and the drawings.

### BRIEF DESCRIPTION OF THE DRAWINGS

Several of the drawings show different views of the embodiments. The different views/details have been indicated close to the number of the figure. Thus, e.g. the drawing FIG. 1a shows the view/detail Ia of FIG. 1b. This is indicated by the reference “(Ia)” near the figure number “FIG. 1a”. In line with this, one can see the text “FIG. 1a (Ia)” on the figure page 1/14. Similar notation is used in other figures, too, as detailed below.

FIG. 1a shows in a side view Ia, the side view Ia being indicated in FIG. 1b, a wall for a fluidized bed boiler,

FIG. 1b shows in a front view Ib, the front view Ib indicated in FIG. 1a, the wall of FIG. 1a for a fluidized bed boiler,

FIG. 1c shows in a first top view Ic, the first top view Ic indicated in FIG. 1b, the wall of FIGS. 1a and 1b for a fluidized bed boiler,

FIG. 1d shows in a second top view Id, the second top view Id indicated in FIG. 1b, the wall of FIGS. 1a and 1b for a fluidized bed boiler,

FIG. 2a shows in a side view 11a, the side view 11a being indicated in FIG. 2b, a part of a wall for a fluidized bed boiler, the part not including the refractory 230 of FIGS. 1a to 1d,

FIG. 2b shows in a front view IIb, the front view IIb being indicated in FIG. 2a, a part of a wall for a fluidized bed boiler, the part not including the refractory 230 of FIGS. 1a to 1d,

FIG. 2c shows in a top view 11c, the top view 11c indicated in FIG. 2b, the part of the wall of FIGS. 2a and 2b for a fluidized bed boiler,

FIG. 2d shows in a top view IId, the top view IId indicated in FIG. 2b, the part of the wall of FIGS. 2a and 2b for a fluidized bed boiler,

FIG. 2e shows in a top view IId, the top view IId indicated in FIG. 2b, a part of a wall having heat exchanger pipes provided with an overlay (119, 129, 139), and the outer diameters of the heat exchanger pipes in such a case,

FIG. 3a shows in a side view a circulating fluidized bed boiler having a wall, shows in a top view IIIb, the top view IIIb indicated in FIG. 3a, the FIG. 3b circulating fluidized bed boiler,

FIG. 3c shows in another side view the circulating fluidized bed boiler of FIG. 3a,

FIG. 4a shows in a front view a wall for a fluidized bed boiler,

FIG. 4b shows in a top view IVb, the top view IVb indicated in FIG. 4a the wall for a fluidized bed boiler,

FIG. 4c shows in a front view a wall for a fluidized bed boiler,

FIG. 4d shows in a front view a wall for a fluidized bed boiler,

FIG. 5a shows in a side view a circulating fluidized bed boiler having a wall,

FIG. 5b shows the detail Vb of FIG. 5a in more detail,

FIG. 5c shows in a top view Vc, the top view Vc indicated in FIG. 5b, a part of a wall for a fluidized bed boiler,

FIG. 6 shows, in a similar view as FIG. 1a, a wall having refractory that tapers upwards,

FIG. 7a shows in a side view a circulating fluidized bed boiler having a wall that comprises two mutually perpendicular planar parts,

FIG. 7b shows in a top view, walls of the circulating fluidized bed boiler of FIG. 7a,

FIG. 8a shows in a front view Villa, the front view Villa indicated in FIG. 8c, a wall for a fluidized bed boiler, the wall comprising a wing,

FIG. 8b shows in a top view VIIIb, the top view VIIIb indicated in FIG. 8a, the wall of FIG. 8a for a fluidized bed boiler,

FIG. 8c shows in a side view VIIIc, the side view VIIIc being indicated in FIG. 8a, a part of a wall for a fluidized bed boiler, the wall comprising a wing,

FIG. 8d shows in a side view a part of a fluidized bed boiler comprising a wall, the wall comprising a wing,

FIG. 8e shows in a side view a part of a fluidized bed boiler comprising a wall, the wall comprising a wing,

FIG. 8f shows in a front view a wall for a fluidized bed boiler, the wall comprising a wing,

FIG. 8g shows in a top view VIIIg, the top view VIIIg indicated in FIG. 8f, the wall of FIG. 8f for a fluidized bed boiler,

FIG. 9a shows in a top view, a known wall of a fluidized bed boiler and a vortexes formed in use, and

FIG. 9b shows in a side view the known wall of FIG. 9a in a vortex.

In the Figures, the directions Sx, Sy, and Sz are three mutually orthogonal directions. In a preferable use, the direction Sz is reverse to gravity (i.e. Sz is upwards and vertical).

### DETAILED DESCRIPTION

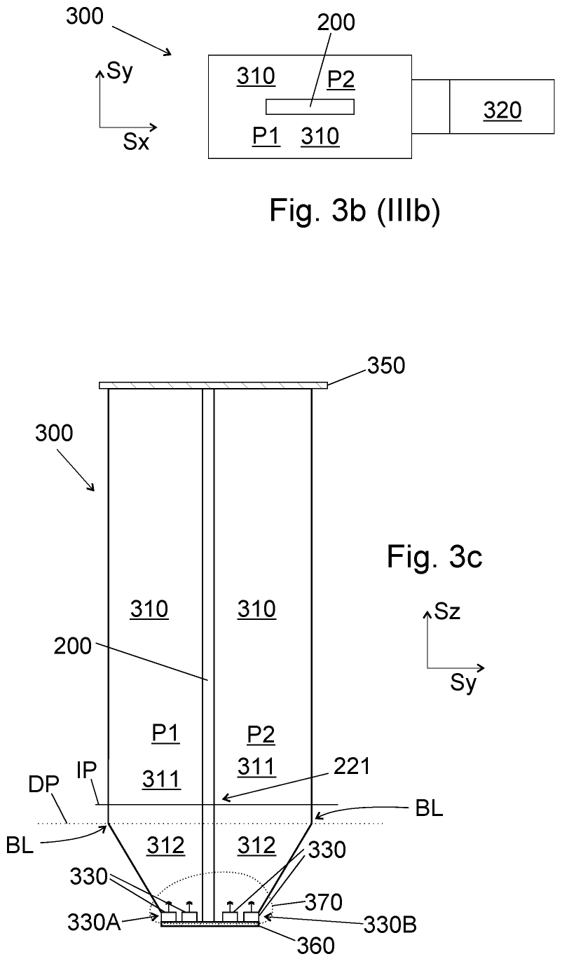

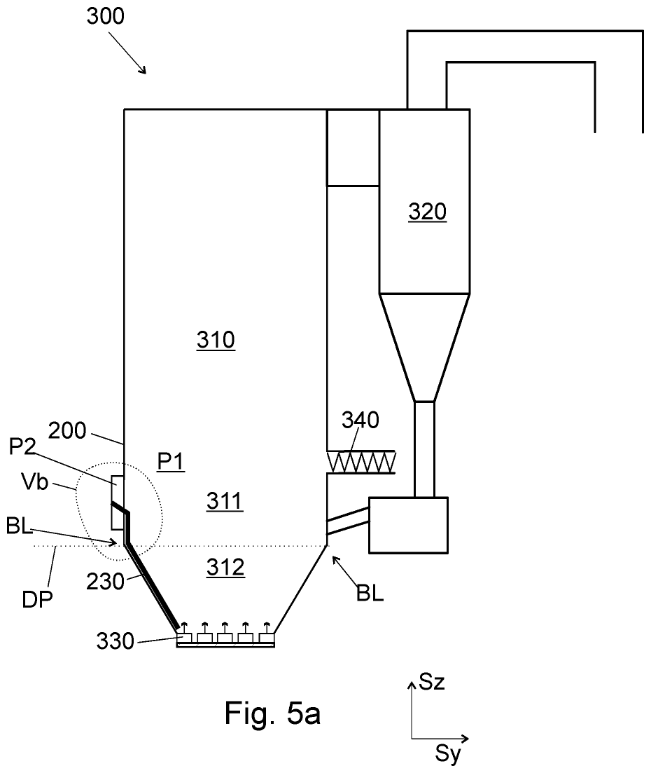

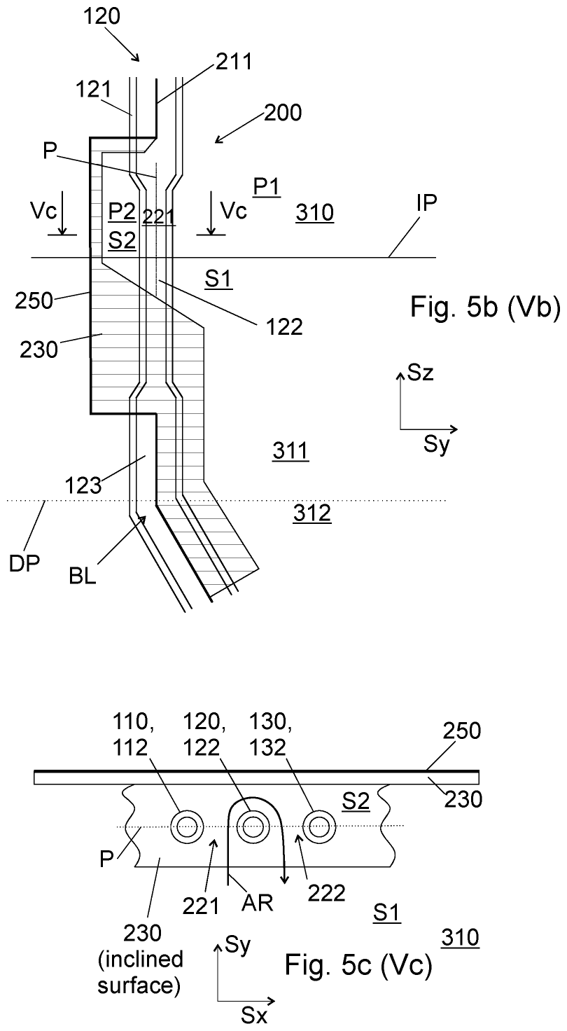

The invention relates to a fluidized bed boiler 300. A fluidized bed boiler 300 is shown in FIGS. 3a to 3c in various views. The fluidized bed boiler 300 of FIGS. 3a to 3c is a circulating fluidized bed boiler. Another fluidized bed boiler 300 is shown in FIG. 5a. The fluidized bed boiler 300 comprises a furnace 310. The fluidized bed boiler 300 comprises walls. Some of the walls limit the furnace 310. A division wall may divide the furnace 310 to two parts such that combustion takes place on both sides. The invention relates to a wall 200 of the fluidized bed boiler 300. The wall 200 may be a division wall, as depicted in FIGS. 3a to 3c. In the alternative, the wall 200 may be a side wall of the furnace 310 as shown in FIGS. 5a to 5c. Naturally, a fluidized bed boiler may comprise both a wall 200 having the structure disclosed in detail below as a division wall and another wall 200 have the having the structure disclosed in detail below as a side wall.

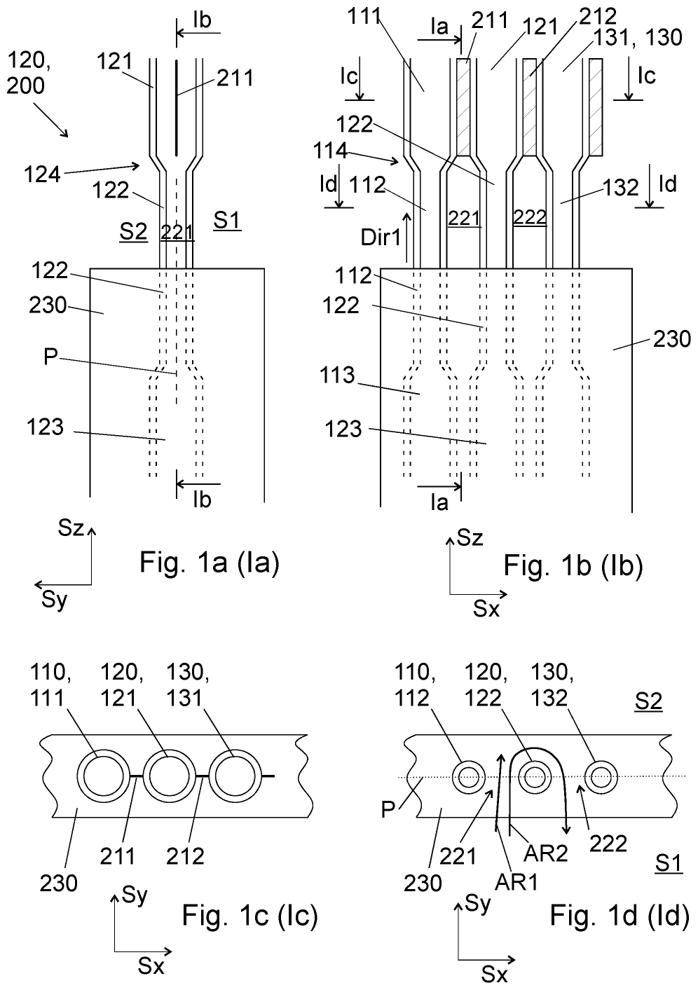

FIGS. 1a to 1d show, in various views, a wall 200 for a fluidized bed boiler. Referring to FIGS. 1b to 1d the wall 200 comprises a first heat exchanger pipe 110 and a second heat exchanger pipe 120. A purpose of the heat exchanger pipes 110, 120 is to recover heat from the furnace 310. Another purpose of the heat exchanger pipes 110, 120 is, in an embodiment, to carry mechanical load. Another purpose of the heat exchanger pipes 110, 120 is, in an embodiment, to prevent material from escaping the furnace. The first heat exchanger pipe 110 comprises a first primary portion 111 and a first secondary portion 112. The second heat exchanger pipe 120 is arranged in parallel with the first heat exchanger pipe 120 and comprises a second primary portion 121 and a second secondary portion 122.

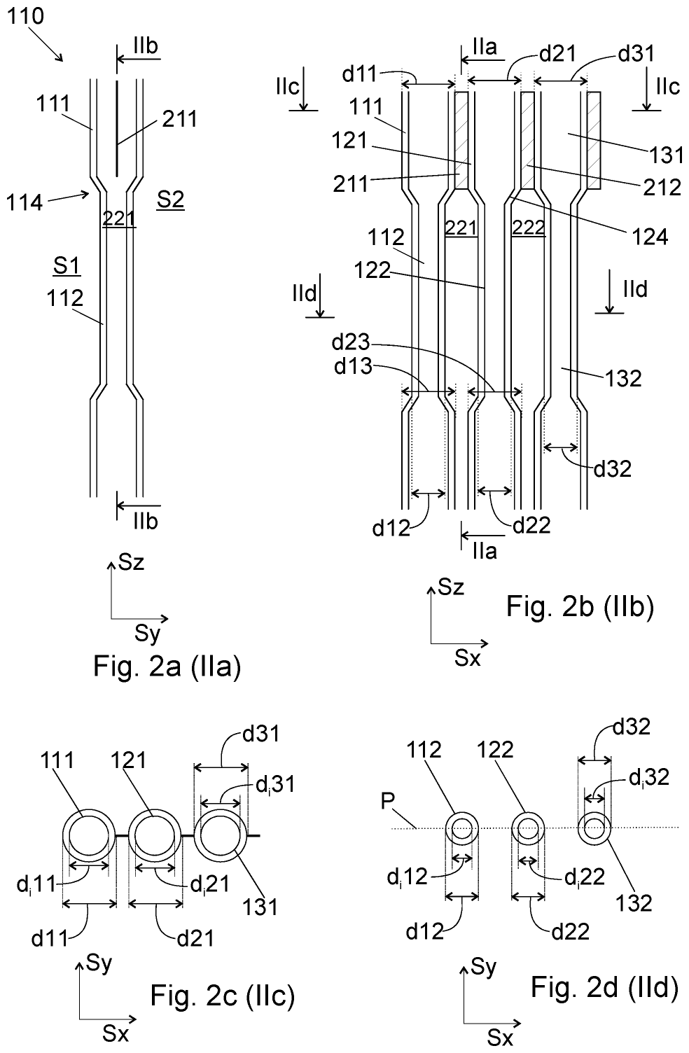

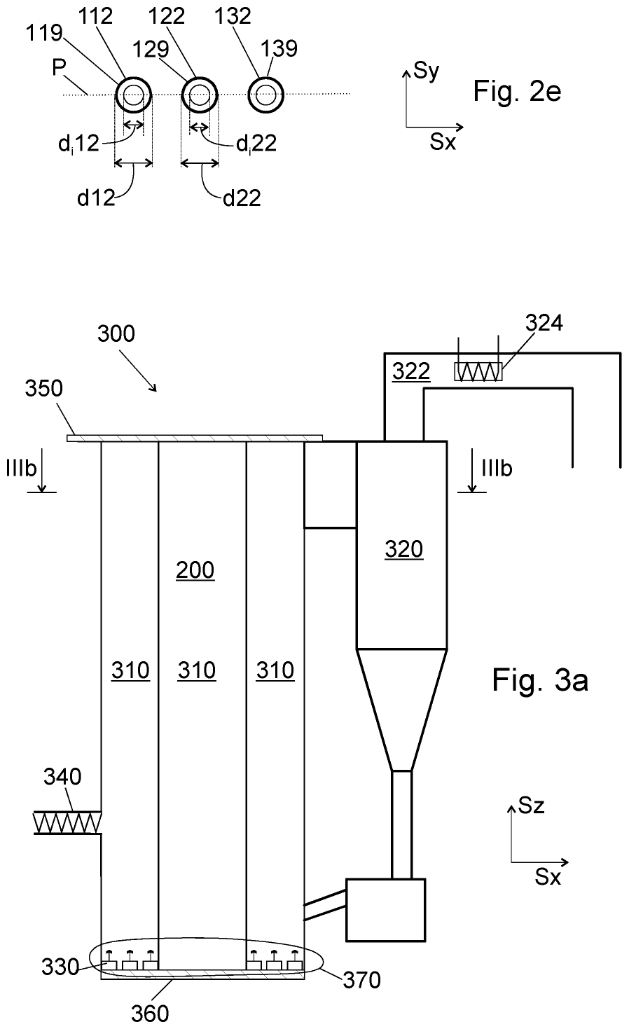

As for the terminology of these portions and with reference to FIGS. 2c and 2d, an outer diameter d12 of the first secondary portion 112 is less than or equal to an outer diameter d11 of the first primary portion 111. Moreover, an outer diameter d22 of the second secondary portion 122 is less than or equal to an outer diameter d21 of the secondary primary portion 121. In use, the first primary portion 111 is arranged above the first secondary portion 112, and the secondary primary portion 121 is arranged above the second secondary portion 122, as shown in FIGS. 1a, 1b, 2a, and 2b. For definition of the direction Sz, see above. These features have the effect that the bed material, flowing along the wall 200 downwards (in the negative Sz direction) flows without forming vortexes at a boundary between the primary portions (111, 121) and the secondary portions (112, 122) as there are not protrusions when moving from a side of the primary portions (111, 121) to a side of the secondary portions (112, 122). It is also noted that in an embodiment, the secondary portions (112, 122) are provided with an overlay. Herein the outer diameter refers to an outer diameter of the overlay of the secondary portion, when an overlay has been provided, as shown in FIG. 2e. If an overlay is not provided, the outer diameter refers to an outer diameter of the plain secondary portion, as shown in FIG. 2d. This definition ensures that even if the overlay is provided, the vortex is not generated, as discussed above. Preferably, the first secondary portion 112 is co-axial with the first primary portion 111; and the second secondary portion 122 is co-axial with the second primary portion 121. This in connection with the outer diameters thereof ensure that the secondary portions (112, 122) do not protrude from the from a tubular curtain defined by the primary positions (111, 121).

Referring to FIGS. 1b and 1c, the wall 200 comprises a first connector, e.g. first fin 211. In FIGS. 1b and 1b a first fin 211 serves as the first connector. However, as will be detailed below, in the alternative, an auxiliary heat transfer surface 241 may serve as the first connector. In what follows, the first fin 211 is used as an example of the first connector, unless otherwise indicated.

The first fin 211 is fixed to the first primary portion 111 and to the second primary portion 121. A purpose of the first fin 211 is to tie the first heat exchanger pipe 110 and the second heat exchanger pipe 120 so as to improve the integrity of the wall 200. Moreover, when the wall 200 is used as a side wall of a furnace 310, the first fin 211 prevents gases and bed material from escaping from the furnace 310 between the first primary portion 111 the second primary portion 121.

In the more general case, the first connector (e.g. the first fin 211 or the first auxiliary heat transfer surface 241) is fixed to the first primary portion 111 and to the second primary portion 121. A purpose of the first connector is to tie the first heat exchanger pipe 110 and the second heat exchanger pipe 120 so as to improve the integrity of the wall 200. Moreover, when the wall 200 is used as a side wall of a furnace 310, the first connector prevents gases and bed material from escaping from the furnace 310 between the first primary portion 111 the second primary portion 121.

Referring to FIGS. 1a and 1d, in the wall 200, at least a part of the first secondary portion 112 and at least a part of the second secondary portion 122 extend straight, in parallel, and within an imaginable plane P. The plane P is imaginable, i.e. it is not a physical object, but a plane as well known in the field of geometry. In an embodiment, at least the part of the first secondary portion 112 and at least the part of the second secondary portion 122 extend straight and in parallel so that the central axes of these parts belong to the plane P.

Referring to FIGS. 1b and 1d, the wall 200 comprises a first gap 221. The first gap 221 is arranged between the first secondary portion 112 and the second secondary portion 122. In FIG. 1a, the first gap 221 is arranged in front of the second secondary portion 122 (i.e. the first gap 221 is towards the reader from the second secondary portion 122).

The wall 200 is configured such that at least a part of the first gap 221 penetrates through the plane P, whereby gases and bed material can propagate through the first gap 221. Thus, the wall 200 is configured such that at least a part of the first gap 221 penetrates through the plane P such that particulate material (i.e. bed material, and thus also gas) can propagate (i.e. the particulate material is able to propagate) through the first gap 221 from a first side S1 of the plane P to the opposite second side S2 of the plane P. Naturally this feature is not a feature concerning the particulate material as such, which is arranged in the furnace 310 in use. In other words, the wall 200 is free from such parts that would prevent the particulate material or the gases from propagating through at least a part of the first gap 221 and through the plane P from a first side S1 of the plane P to the opposite second side S2 of the plane P.

Propagation of the particulate material (i.e. bed material) through at least a part of the first gap 221 and through the plane P from a first side S1 of the plane P to the opposite second side S2 of the plane P is shown by the arrow AR1 in FIG. 1d.

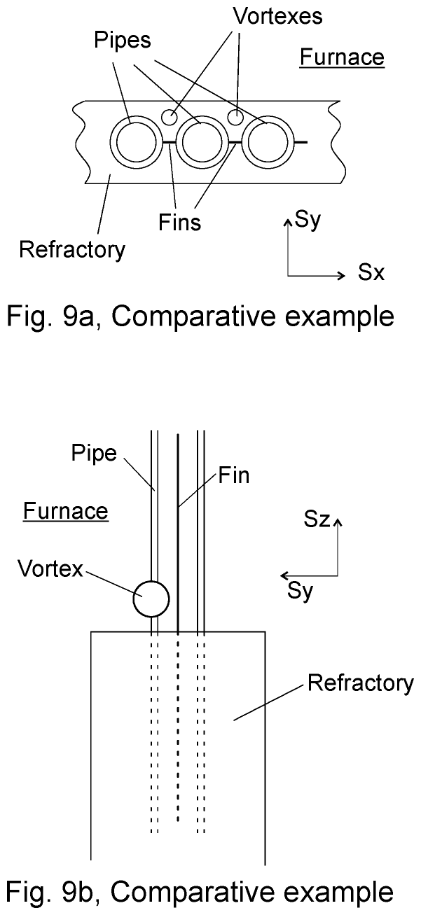

In has been found that when the particulate material (i.e. bed material) can propagate in such a way, if a vortex is formed within the first gap 221, the vortex spreads to a much larger area and generates less erosion to the heat exchanger pipes. Such a vortex may form e.g. if the secondary parts 112, 112 of the heat exchanger pipes are connected by a plate on the second side S2 (not shown) instead of the fin of FIG. 9a. Naturally, the fin of FIG. 9a prevents the particulate material (i.e. bed material) from propagating from a first side of the wall to an opposite second side of the wall, because this is one of the main tasks of the fins.

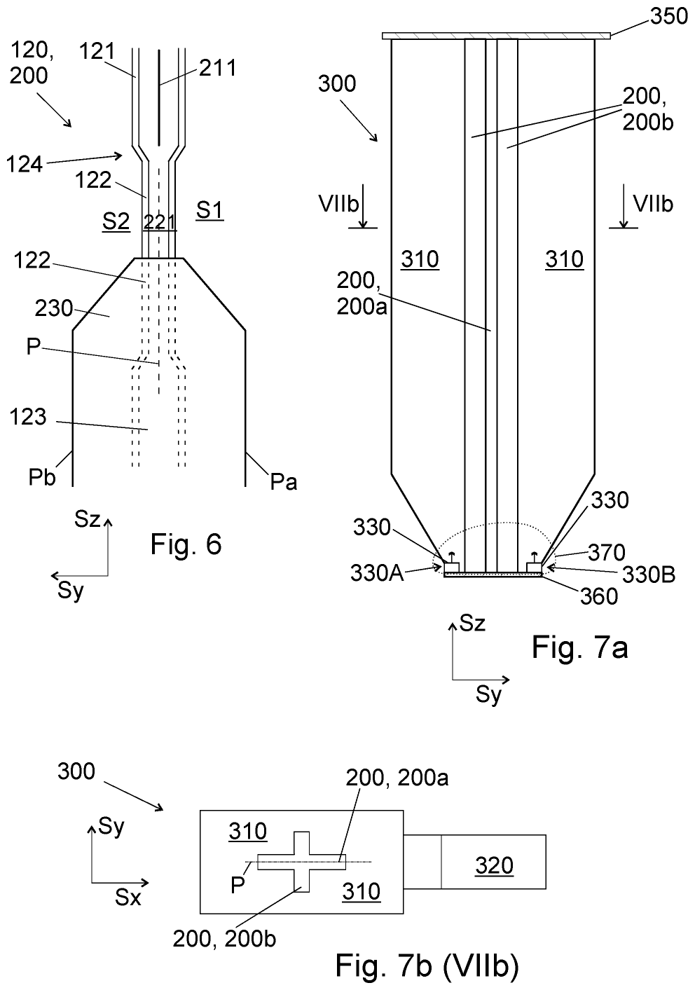

Furthermore, the wall 200 comprises a refractory 230. The refractory 230 is arranged on at least one side of both a part of the first secondary portion 112 and a part of the second secondary portion 122. Preferably, the refractory 230 is arranged on both sides of a part of the first secondary portion 112 and a part of the second secondary portion 122. Thus, in an embodiment, a part of the refractory 230 laterally surrounds both a part of the first secondary portion 112 and a part of the second secondary portion 122. A function of the refractory 230 is to protect the part of the first secondary portion 112 and the part of the second secondary portion 122. For protecting the secondary portions 112 and 122 a thickness of the refractory is preferably 25 mm to 100 mm. Herein the thickness refers to a thickness of the refractory on the first secondary portion 112; i.e. a thickness of refractory between the open space of the furnace 310 and the outer surface of the first secondary portion 112. A top surface of the refractory 230 may be planar and horizontal as shown in FIG. 1a. However, to ease flow of the particulate material, the refractory may have a shape that tapers upwards, as shown in FIG. 6, and also in FIG. 5b. In these figures, a top surface of the refractory 230 comprises an inclined part.

In the wall 200, a part of the first secondary portion 112 extends from the refractory 230 to a first direction Dir1, a part of the second secondary portion 122 extends from the refractory 230 to the first direction Dir1, and the first gap 221 extends from the refractory 230 to the first direction Dir1. The first direction Dir1 is a direction of the plane P and perpendicular to a direction that is directed from a first point on a central axis of the first secondary portion 112 to a second point on a central axis of the second secondary portion 122, wherein the second point is on the central axis of the second secondary portion 122 and the point closest to the first point. The first direction Dir1 is preferably more or less upwards vertical, as more specifically detailed below. Thus, the first gap 221 is arranged to such a location, at which, without the first gap 221, the highly localized erosion would take place. A possible reason could be the formation of a highly localized vortex. Such a location is depicted in FIGS. 9a and 9b. However, providing more space for such vortex will result is less localized erosion. Thus, as shown in FIGS. 1a, 1b, and 1d according to the embodiment, the first gap 221 is arranged at a similar location to prevent the formation of the vortex or to at least increase a size of the vortex.

In line with what has been said above, in an embodiment the first secondary portion 112 is not provided with a fin or fins, whereby a shape of an outer contour of a cross section of a body of the first secondary portion 112 is circular throughout a length of the first secondary portion 112. Moreover, in an embodiment, the second secondary portion 122 is not provided with a fin or fins, whereby a shape of an outer contour of a cross section of a body of the second secondary 122 portion is circular throughout a length of the second secondary portion 122. Herein the term “body” refers to the (first, second, . . . ) secondary portion (112, 122) if the (first, second, . . . ) secondary portion (112, 122) has not been provided with a (first, second, . . . ) overlay 119, 129. However, if the (first, second, . . . ) secondary portion (112, 122) comprises the (first, second, . . . ) overlay (119, 129), the term “body” refers to (first, second, . . . ) secondary portion (112, 122) without the (first, second, . . . ) overlay (119, 129). In general, the overlay, if used, is made from different material than the body.

Referring to FIG. 1d, it has also been found that when the particulate material can return to the first side S1 through another gap, a vortex is not generated at all, or at least the tendency of forming such a vortex is significantly reduced. Thus, a more preferable embodiment of the wall comprises a third heat exchanger pipe 130, which limits a second gap 222, through which the particulate material can return, as detailed below. A path for the bed material through two gaps is shown by the arrow AR2 in FIG. 1d.

In this embodiment, the third heat exchanger pipe 130 is arranged in parallel with the second heat exchanger pipe 120 and comprises a third primary portion 131 and a third secondary portion 132. Reference is made to FIGS. 1a to 1d. A second fin 212 (or second connector, e.g. second auxiliary heat transfer surface) is fixed to the second primary portion 121 and to the third primary portion 131 for similar reasons as the first fin 211 (or first connector) is fixed to the heat exchanger pipes 110, 120. Moreover, at least a part of the first secondary portion 121, at least a part of the second secondary portion 122, and at least a part of the third secondary portion 132 extend straight, in parallel, and within the imaginable plane P. In an embodiment, at least the part of the first secondary portion 112, at least the part of the second secondary portion 122 and at least the part of the third secondary portion 132 extend straight and in parallel so that the central axes of these parts belong to the plane P.

In this embodiment, the wall 200 comprises a second gap 222. The second gap 222 is arranged between the second secondary portion 122 and the third secondary portion 132 (see FIGS. 1b and 1d). Moreover, the wall 200 is configured such that at least a part of the second gap 222 penetrates through the plane P. Moreover, the particulate material can propagate (i.e. is able to propagate) through the first gap 221 from the first side S1 of the plane P to the opposite second side S2 of the plane P (as detailed above), and the particulate material can return (i.e. is able to return) through the second gap 222 from the second side S2 of the plane P to the first side S1 of the plane P. The particulate material may, e.g., go round a side of the second secondary portion 122 on the second side S2 of the plane P the first gap 221 to the second gap 221. Such propagation of the particulate material is shown by the arrow AR2 in FIG. 1d. Naturally this feature is not a feature concerning the particulate material as such, which is arranged in the furnace 310 in use. In other words, in this embodiment, the wall 200 is free from such parts that would prevent the particulate material from
propagating through at least a part of the first gap 221 and through the plane P from a first side S1 of the plane P to the opposite second side S2 of the plane P, and
returning through the second gap 222 from the second side S2 of the plane P to the first side S1 of the plane P.

Preferably, the wall is also free from such parts that would prevent the particulate material from going round a side of the second secondary portion 122 on the second side S2 of the plane P from the first gap 221 to the second gap 221. For example, if the wall 200 is used as a division wall (see FIGS. 3a to 3c), bed material is able to propagate from the first side S1 to the second side S2 and from the second side to the first side S2 through the gaps 221, 222. However, in use, the bed material does not immediately return to the first side, nor does it typically go round the pipe along a shortest possible route. Instead, the bed material may circulate some time on the second side S2 before returning back to the first side S1.

In this embodiment, the tendency of forming the vortexes is reduced as the particulate material may go through the first gap 221 and return to the first side S1 through the second gap 222. Thus the particulate needs not return through the same first gap 221, which would form a vortex of some kind. It is also noted that the bed material needs not go round the side of the second secondary portion 122 on the second side S2 of the plane P near the second secondary portion 122 on the second side S2. Instead, in particular when the wall 200 is used as a division wall, the bed material may circulate some time on the second side S2 before returning back to the first side S1.

In this embodiment, a part of the third secondary portion 132 extends from the refractory 230 to the first direction Dir1, and the second gap 222 extends from the refractory 230 to the first direction Dir1. Moreover, for reasons detailed above, preferably, an outer diameter d32 of the third secondary portion 132 is less than or equal to an outer diameter d31 of the third primary portion 131.

The wall 200 of FIGS. 1a to 1d is shown without the refractory 230 in FIGS. 2a to 2d. FIGS. 2a to 2d also show some measures of the heat exchanger pipes 110, 120, 130. Referring to FIGS. 1a to 1d and 2a to 2d, in an embodiment, the first secondary portion 112 has a first profile shape extending in a longitudinal direction of the first secondary portion 112 such that the first profile shape has a constant outer diameter d12 throughout the length of the first secondary portion 112, the length of the first secondary portion 112 being more than zero. In the embodiment, this applies in particular to the body of the first secondary portion 112. This has the benefit that the first secondary portion 112 of the first heat exchanger pipe 110 can be manufactured by using a pipe having a smaller outer diameter than the first primary portion 111 of the first heat exchanger pipe 110. The first secondary portion 112 may be e.g. welded to the first primary portion 111. Another suitable manufacturing technique for forming the first secondary portion 112 is to turn a pipe, which has reasonable thick wall, with a lathe to reduce the outer diameter of the first secondary portion 112. However, joining two pipes with different outer diameters is oftentimes economically more feasible.

When the heat exchanger pipe has been made by joining different types tubes to form the portions 111, 112, preferably, an inner diameter di12 of the first secondary portion 112 is less than an inner diameter di11 of the first primary portion 111 and an inner diameter di22 of the second secondary portion 122 is less than an inner diameter di21 of the second primary portion 121. This has the effects that, on one hand, the primary portions 111, 121 form a smaller flow resistance, because their inner diameter is large, and on the other hand all the portions 111, 112, 121, 122 of the pipes may have a sufficient, but not excessive, pressure and temperature resistance.

For similar reasons, in the embodiment, the second secondary portion 122 has a second profile shape extending in a longitudinal direction of the second secondary portion 122 such that the second profile shape has a constant outer diameter d22 throughout the length of the second secondary portion 122, the length of the second secondary portion being more than zero. In the embodiment, this applies in particular to the body of the second secondary portion 122.

In an embodiment, the secondary portions 112, 122 are provided with overlays 119, 129. In an embodiment, the body of first secondary portion 112, i.e. the first secondary portion 112 without the overlay 119, has a first profile shape extending in a longitudinal direction of the first secondary portion 112 such that the first profile shape has a constant outer diameter d12 throughout the length of the first secondary portion 112. In an embodiment, the body of second secondary portion 122, i.e. the second secondary portion 122 without the overlay 129, has a second profile shape extending in a longitudinal direction of the second secondary portion 122 such that the second profile shape has a constant outer diameter d22 throughout the length of the second secondary portion 122.

In such a case, preferably, only a part of the first secondary portion 112 is covered by the refractory 230 and only part of the second secondary portion 122 is covered by the refractory 230. In such a case, a part of the first secondary portion 112 (which may have the constant outer diameter) limits the first gap 221, and a part of the second secondary portion 122 (which may have the constant outer diameter) limits the first gap 221. In such a case, the first gap 221 is reasonable large for allowing the particulate material to enter the second side S2 from the first side S1, which ensures the spreading of the vortex and/or the propagation of the bed material from first side to second side and the returning thereof as discussed above.

In an embodiment, the first primary portion 111 has a third profile shape extending in a longitudinal direction of the first primary portion 111 such that the third profile shape has a constant outer diameter d11 throughout the length of the first primary portion 111, the length of the first primary portion 111 being more than zero. In a similar manner, in an embodiment, the second primary portion 121 has a fourth profile shape extending in a longitudinal direction of the second primary portion 121 such that the fourth profile shape has a constant outer diameter d21 throughout the length of the second primary portion 121, the length of the second primary portion being more than zero.

Moreover, the first secondary portion 112 needs not be directly connected to the first primary portion 111. Thus, in an embodiment, the first heat exchanger pipe 110 comprises a first primary connecting portion 114 connecting the first primary portion 111 to the first secondary portion 112; and the second heat exchanger pipe 120 comprises a second primary connecting portion 124 connecting the second primary portion 121 to the second secondary portion 122. Reference is made to FIGS. 1a, 1b, 2a, and 2b.

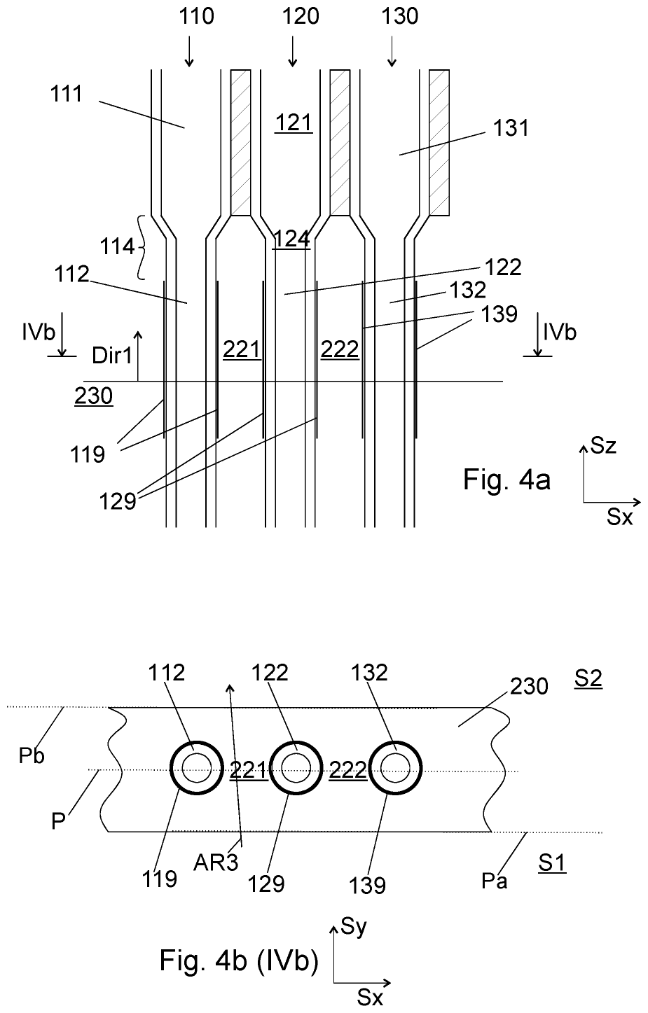

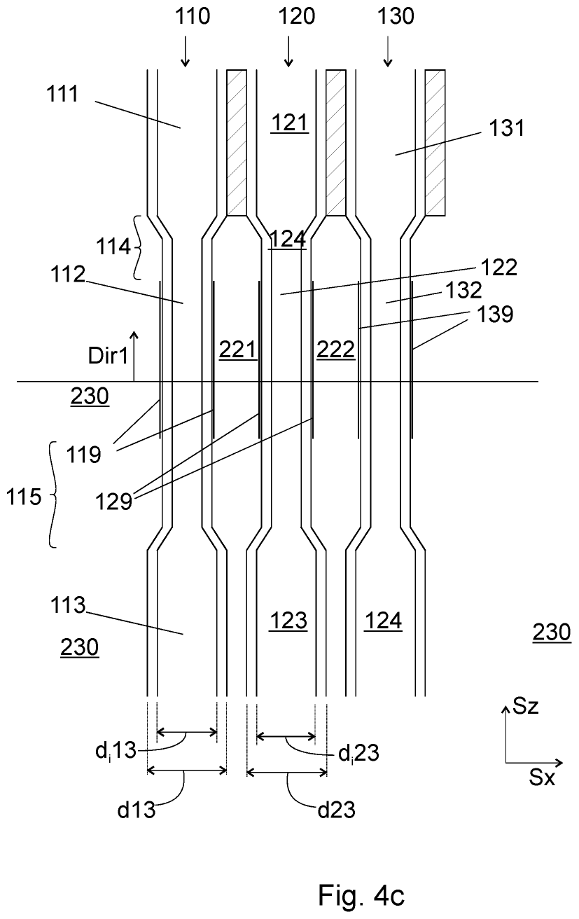

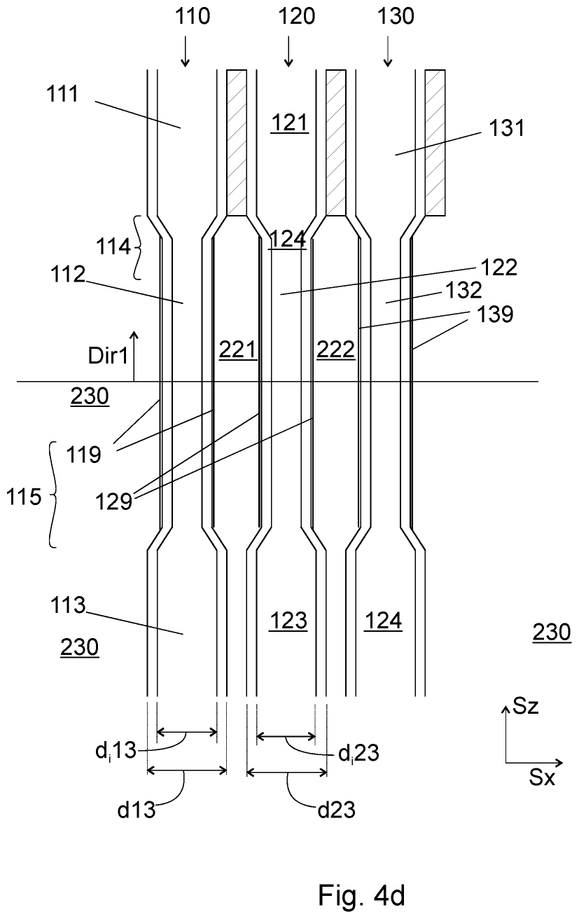

The erosion resistance or maintainability of the (first, second, third) secondary portions 112, 122, 132 can further be improved by using an overlay (119, 129, 139). Such overlays 119, 129, 139 are shown in FIGS. 4a to 4d and 2e. The overlay preferably comprises erosion-resistant metal or ceramic. However, it may comprise sacrificial metal, which need not be erosion-resistant. The overlay 119, 129, 139 may be in the form of a tube, into which the (body of the) secondary portion 112, 122, 132 is pushed while manufacturing the heat exchanger pipe 110, 120, 130. In the alternative, the overlay may be sprayed onto the body of the secondary portion 112, 122, 132. As a further the alternative, in case the overlay comprises metal, the overlay may be welded onto the a body of the secondary portion 112, 122, 132. Preferably, the overlay 119, 129, 139 is an overlay welding comprising suitable alloy. The overlay 119, 129, 139 may form a part of the secondary portion 112, 122, 132. It has been noticed that a weld overlay cladding by materials having at least 20% Cr and a low Fe content on the surfaces exposed to furnace gases significantly reduces the wall erosion. Examples of suitable alloys include Alloy 625 (Ni—22Cr—9Mo—3.5Nb). However, the overlay need not be extremely resistant to abrasion, because a technical function of the overlay may be to serve as a sacrificial layer. Thus, the wall 200 may be maintained by adding more sacrificial material after a period of use, if needed, without the need of replacing the tube itself.

The overlay 119, 129 may be machined, e.g. turned after having been welded onto the secondary portion 112, 122, 132. As an example, a tube intended for use as the secondary portion can be first covered (e.g. welded) with the overlay. Thereafter, particular if the overlay has a variable thickness, the tube can be turned to level out the variance of the thickness of the overlay. This ensures that the secondary portion do comprise protrusions that would cause further generation of vortexes. Moreover, this may help to reduces a difference between the outer diameter of the primary parts 111, 121 and the secondary parts 112, 122.

The overlay 119, 129, 139, if used, is preferably provided at such a location wherein the particulate material has a tendency of propagating in the direction of normal of the wall 200. Moreover, it is the refractory 230 that causes the tendency of the particulate material to propagate in the direction of normal of the wall 200. Thus, the overlay 119, 129 is provided such that the overlay 119, 129 limits the first gap 221 and extends from the refractory 230. That is, a non-overlaid portion of the heat exchanger pipe is not arranged between the refractory an overlaid part of the heat exchanger pipe in the longitudinal direction of the heat exchanger pipe.

Thus, in an embodiment, the wall 200 comprises a first overlay 119 arranged on at least a part of the first secondary portion 112 and a second overlay 129 arranged on at least a part of the second secondary portion 122. Reference is made to FIGS. 4a and 4b. Thus, the first overlay 119 forms a part of a surface of the first secondary portion 112; and the second overlay 129 forms a part of a surface of the second secondary portion 122.

At least a part of the first overlay 119 extends from the refractory 230 to the first direction Dir1 on the first secondary portion 112 and laterally fully encircles at least a part of the first secondary portion 112. Thus, at least a part of the first overlay 119 limits the first gap 221. As shown in FIG. 4a, the first overlay 119 needs not cover the whole first secondary portion 112 in the longitudinal direction (Sz in FIG. 4a). However, as indicated above, laterally the first overlay 119 fully encircles at least a part the first secondary portion 112.

In a similar manner, at least a part of the second overlay 129 extends from the refractory 230 to the first direction Dir1 on the second secondary portion 122 and laterally fully encircles at least a part of the second secondary portion 122.

In this way, at least a part of the first overlay 119 limits the first gap 221 and at least a part of the second overlay 129 limits the first gap 221. As shown in FIG. 4a, the first gap may also by limited by non-overlaid parts of the first secondary portion 112 and the second secondary portion 122.

In line with what has been said above, the first overlay 119 comprises metal or ceramic, and the second overlay 129 comprises metal or ceramic. The materials, such as alloys, disclosed above are usable.

Referring to FIG. 4d, preferably, the first overlay 119 extends in the first direction Dir1 to the first primary connecting portion 114 (if present) or to the first primary portion 111. In a similar way, preferably, the second overlay 129 extends in the first direction Dir1 to the second primary connecting portion 124 (if present) or to the second primary portion 121. In this case the overlay 119, 129 protects the rest of the secondary portions 112, 122.

However, near the primary portions 111, 121, the bed material tends to fall downwards along the primary portions 111, 121. Thus, the bed material has a tendency of continuing propagating in the same direction (i.e. reverse to the first direction Dir1) also below the primary portions 111, 121. This tendency forms a curtain, along which the bed material normally falls, at least for some distance, but not necessary until the surface of the refractory 230. The areas of the secondary portions 112, 122 that remain between this curtain and the imaginable plane P are not exposed to high erosion.

As detailed above, the secondary portions 112, 122 do not protrude from the curtain defined by the outer surfaces of the primary portions 111, 121. In particular, in an embodiment, the secondary portions 112, 122 are co-axial with the primary portions 111, 121 and have a smaller outer diameter, whereby upper parts of the secondary portions 112, 122 are arranged in a shadow of the primary parts 111, 121 (i.e. between the imaginable plane P and the curtain). Thus, upper parts of the secondary parts 112, 122 need not comprise an overlay (see FIG. 4c). However, because the refractory 230 guides the bed material towards the plane P, preferably, the overlays 119, 129 are used; and they extend for a certain distance from the refractory 230 in the first direction Dir1.

Preferably, the wall 200 comprises the third heat exchanger pipe 130 as discussed above. Moreover, in such a case, at least a part of the second overlay 129 limits also the second gap 222. In an embodiment, the wall 200 comprises a third overlay 139 arranged on at least a part of the third secondary portion 132. At least a part of the third overlay 139 limits the second gap 222 in a similar manner as detailed above for the other overlays 119, 129.

To ensure that even if the refractory 230 wears, a non-overlaid part is not exposed to erosion, preferably, the overlays 119, 129, 139 extend also into the refractory, i.e. the overlays extend from the interface of the refractory to the reverse first direction-Dir1.

In such a case and in a preferable embodiment, a part of the first overlay 119 is arranged laterally between the first secondary portion 112 and the refractory 230. More specifically, and considering that the first overlay 119 forms a part of the first secondary portion 112, a part of the first overlay 119 is arranged laterally between an inner surface of the first secondary portion 112 and the refractory 230. In a similar way, a part of the second overlay 129 is arranged laterally between the second secondary portion 122 and the refractory 230. More specifically, and considering that the second overlay 129 forms a part of the second secondary portion 122, a part of the second overlay 129 is arranged laterally between an inner surface of the second secondary portion 122 and the refractory 230. Reference is made to FIGS. 4a and 4b.

Preferably, the first overlay 119 comprises metal alloy and is an overlay welding, and the second overlay 129 comprises metal alloy and is an overlay welding. Preferably, a thickness of the first overlay 119 is 1 mm to 4 mm, more preferably 2 mm to 3 mm. Preferably, a thickness of the second overlay 129 is 1 mm to 4 mm, more preferably 2 mm to 3 mm.

Particularly preferably the wall 200 is used as a division wall of furnace of a fluidized bed boiler, such as a circulating fluidized bed boiler (FIGS. 3a to 3c) and the secondary portions 112, 122, 132 are provided with the overlays 119, 129, 139. In addition, when the wall 200 is used as a division wall, preferably, the refractory 230 is arranged between two planes Pa and Pb that are parallel to the plane P defined above, as show in FIG. 4b. Preferably, in this embodiment, the refractory 230 is arranged between a first plane Pa and a second plane Pb that are parallel to the imaginable plane P, in which at least a part of the first secondary portion 112 and at least a part of the second secondary portion 122 extend straight; and the wall 200 is configured such that particulate material (i.e. bed material) can propagate (i.e. the particulate material is able to propagate) through the first gap 221 from a first side S1 of the first plane Pa to an opposite second side S2 of the second plane Pb. Such propagation of bed material is shown in FIG. 4b by the arrow AR3.

This has the benefit that bed material, once having propagated from the first side S1 of the first plane Pa through the first gap 221 to the opposite second side S2 of the second plane Pb, is able to fall downwards on the second side S2, which further reduces the tendency of forming vortexes near the refractory 230.

As discussed, the outer diameter of the secondary portions 112, 122, 132 may be substantially constant, and the outer diameter may include an overlay 119, 129, 139, as detailed above. To clarify the definitions, reference is made to FIGS. 4a and 4b. As shown therein in the longitudinal direction (Sz in FIG. 4a), an outer diameter of the secondary portions 112, 122, 132 is constant only as long as the secondary portions 112, 122, 132 are provided with the overlay 119, 129, 139, respectively. However, when the overlay ends, the outer diameter reduces by twice the thickness of the overlay 112, 129, 139. In line with these definitions, in the embodiment of FIG. 4a, the first primary connecting portion 114, which connects the first primary portion 111 to the first secondary portion 112 comprises a taper and a part having a constant outer diameter, the constant outer diameter being equal to a non-overlaid part of the first secondary portion 112. This applies, mutatis mutandis, to the second primary connecting portion 124 and the second secondary portion 122 shown in FIG. 4a.

In an embodiment (to be discussed in detail), the wall 200 is substantially planar and extends downwards to a bearing structure. In such a case, the refractory 230 may extend downwards to a grate or to the bearing structure. Referring to FIGS. 1a and 1b, the heat exchanger pipes may comprise tertiary portions (113, 123, 133) which are wider than the secondary portions (112, 122, 132). However, this is not mandatory. Instead, the secondary portions (112, 122, 132) may extend within the refractory throughout the needed length and only having the outer diameter d12, d22, d32. Referring to FIG. 4a, it may be that only a part of each of the heat exchanger pipes 110, 120, 130 extending within the refractory 230 is covered with the overlay 119, 129, 139. Thus, the outer diameter of the heat exchanger pipes extending within the refractory 230 may even decrease downwards. However, with reference to FIG. 4c, when the heat exchanger pipes 110, 120, 130 are provided with the overlays 119, 129, 139, preferably, the heat exchanger pipes 110, 120, 130 comprise tertiary portions 113, 123, 133 which are wider than the secondary portions (112, 122, 132). In such a case, a first secondary connecting portion 115 may connect the first secondary portion 112 to the first tertiary portion 113. What has been said about the outer diameter of the first secondary portion 112 and the extension of the first primary connecting portion 114 applies, mutatis mutandis, to the first secondary connecting portion 115.

Preferably and with reference to FIGS. 1a, 1b, 4c, and 4d, the first heat exchanger pipe 110 comprises a first tertiary portion 113 and the second heat exchanger pipe 120 comprises a second tertiary portion 123. The first secondary portion 112 is arranged (in the longitudinal direction of the first heat exchanger pipe 110) between the first primary portion 111 and the first tertiary portion 113. The second secondary portion 122 is arranged (in the longitudinal direction of the second heat exchanger pipe 120) between the second primary portion 121 and the second tertiary portion 123. To reduce flow resistance generated by the first and second heat exchanger pipes 110, 120, an inner diameter di13 of the first tertiary portion 113 equals an inner diameter di11 of the first primary portion 111 and an inner diameter di23 of the second tertiary portion 123 equals an inner diameter di21 of the second primary portion 121. Preferably also the inner diameter di13 of the first tertiary portion 113 is greater than an inner diameter di12 of the first secondary portion 112 and the inner diameter di23 of the second tertiary portion 123 is greater than an inner diameter di22 of the second secondary portion 122.

For manufacturing reasons it is preferable that the tertiary portions 113, 123 are similar to the primary portions 111, 121. Thus, preferably also an outer diameter d13 of the first tertiary portion 113 equals an outer diameter d11 of the first primary portion 111, and an outer diameter d23 of the second tertiary portion 123 equals an outer diameter d21 of the second primary portion 121.

To protect the tertiary portions 113, 123 from erosion, in an embodiment, at least a part of the first tertiary portion 113 is covered by the refractory 230 and at least a part of the second tertiary portion 123 is covered by the refractory 230.

Any embodiment of the wall 200 detailed above is particularly usable as a wall of a fluidized bed boiler 300. A fluidized bed boiler 300 is shown in FIGS. 3a to 3c and 5a as well as in FIGS. 7a and 7b. The fluidized bed boiler 300 shown in the figures is of the circulating type. Any embodiment of the wall 200 detailed above is usable as a wall of a bubbling fluidized bed boiler 300.

Thus, the fluidized bed boiler 300 comprises a furnace 310, air nozzles 330 for letting combustion air into the furnace 310, and a fuel inlet 340 for letting fuel into the furnace 310. Reference is made to FIGS. 3a to 3c and 5a as well as in FIGS. 7a and 7b. If the fluidized bed boiler is a circulating fluidized boiler, it comprises a particle separator 320 for separating particulate material from a stream received from the furnace 310 for returning at least some of the separated particulate material back to the furnace 310. In a circulating fluidized bed boiler, the air nozzles 330 are operated so that such an amount of air is fed to the furnace 310 that a mixture of bed material, fuels, ash, air, and flue gas mainly travels upwards in the furnace 310 and further propagates to the particle separator 320. The particle separator 320 preferably comprises a cyclone for separating at least most of the solid materials from the mixture and for returning them back to the furnace 310. The flue gas (i.e. the remaining part of the mixture) is expelled to a flue gas channel 322. The fluidized bed boiler 300 is also provided with a heat exchanger 324 for recovering heat from the furnace 310 and/or from the flue gases. As an example, FIG. 3a shows a heat exchanger 324 arranged in the flue gas channel 322.

The fluidized bed boiler 300 further comprises a least one wall 200 according any embodiment of the wall 200 as detailed above. As detailed in background, even if most of the material flows upwards in the furnace 310, in the vicinity of the wall 200 of the furnace, the material flow may be substantially downwards.

In an embodiment, the wall 200 is a division wall dividing the furnace 310 to two parts that function in a substantially similar way, as detailed in FIGS. 3a to 3c and 7a and 7b. In an embodiment, the wall 200 is a side wall of the furnace 310, as detailed in FIGS. 5a to 5c. In an embodiment, the fluidized bed boiler 300 comprises a first wall according any embodiment of the wall 200 as detailed above and a second wall according any embodiment of the wall 200 as detailed above (not shown). In an embodiment the first wall is a division wall of the furnace and the second wall is a side wall of the furnace. In an embodiment the first wall is a division wall of the furnace and the second wall is another division wall of the furnace. In an embodiment the first wall is a side wall of the furnace and the second wall is a side wall of the furnace.

In what follows, the wall 200 refers to the (sole) wall of the type disclosed above, the first wall, the second wall, or both the first and the second wall.

In the circulating fluidized bed boiler 300, the wall 200 limits the furnace 310 such that at least the first side S1 of the plane P is exposed to a part of the furnace 310. In other words, a part of the furnace 310 is arranged on the first side S1 of the plane. Moreover, in this embodiment at least a part of the refractory 230 is arranged on the first side S1 of the plane P. When arranged in such a way, the gaps 221, 222 as detailed above function in the way discussed above. Moreover, the wall is arranged such that the first direction Dir1 forms an angle of at most 30 degrees with an upward vertical direction Sz. In this way, the first direction Dir1 is, in this embodiment, more or less upwards vertical, as indicated above. This angle also ensures that the gaps 221, 222 function as intended; and that the secondary portions 112, 122 of the heat exchanger pipes 110, 120, which are smaller in their outer diameter than the primary portions 111, 121, have the technical effect as detailed above.

Preferably, the wall 200 is a division wall of the furnace 310. In such a case, on both sides of the wall 200 the bed material has a tendency of flowing downwards along the wall until it hits the refractory 230 (or bed material accumulated thereon). And, at that, point, the bed material is guided in a transverse direction, one of which transverse directions is towards the wall 200. Thus, in this case, the gaps 221, 222 provide for bed material and gas passage from either side of the wall 200 to the opposite side of the wall 200. Thus, the wall 200 has been found particularly effective as a division wall of a fluidized bed boiler 300. Therefore, in an embodiment, a first part P1 of the furnace 310 is arranged on a first side of the wall 200 and a second part P2 of the furnace 310 is arranged on a second, opposite side of the wall 200. In other words, in an embodiment, the first part P1 of the furnace 310 is arranged on a first side of the imaginable plane P defined by the wall and a second part P2 of the furnace 310 is arranged on a second, opposite side of the imaginable plane P. Thus the second side S2 of the plane P is exposed to the second part P2 of the furnace 310. Reference is made to FIGS. 3b and 3c. Also in FIG. 7b the plane P divides the furnace into two parts. Moreover, for dividing the furnace 310 to these two parts (P1, P2) such that they function in a substantially similar manner, the first part P1 of the furnace 310 is provided with a first set 330A of air nozzles 330 for fluidizing bed material in the first part P1 of the furnace 310, and the second part P2 of the furnace 310 is provided with a second set 330B of air nozzles 300 for fluidizing bed material in the second part P2 of the furnace 310 (see FIG. 3c). In this embodiment, preferably, the first and second primary portions (111, 121) and first and second secondary portions (112, 122) of the heat exchanger pipes (110, 120) of the wall 200 extend in the plane P. Thus there is no bend point between the primary portions (111, 121) and the secondary portions (112, 122), which also ensures that both sides of the wall 200 function in a substantially same manner.

One problem, particularly in large fluidized bed boilers is bearing of load. The load is caused on one hand by the parts of the boiler as such, and on the other hand by the particulate material arranged within the furnace 310. In particular, typically the air nozzles 330 are arranged to a grate 370 and the grate bears the load of the particulate material. Thus the grate 370 itself needs to be properly supported. While the side walls of the furnace can bear some load, preferably at least the division wall, which is a wall 200 according to an embodiment disclosed above, bears load. This has the benefit that a division wall can be substantially planar, whereby the heat exchanger pipes of the wall 200 may be straight and substantially vertical. Substantially vertical straight pipes carry load to a much grated extent than e.g. bent pipes or pipes that are not vertical. It is also noted that typically the side walls of a furnace are bent in such a way that their load-bearing capacity is reduced. Reference is made to FIGS. 5a to 5c for a bent pipe. Referring to FIGS. 3a to 3c, 7a, and 7b, the wall 200, when used as a supporting division wall of the furnace 310, can be suspended from a suspension structure 350 and the wall 200 can support a bearing structure 360, which supports the grate 370.

For these reasons, with reference to FIGS. 3a to 3c, 7a, and 7b, a preferable embodiment of the circulating fluidized bed boiler comprises a suspension structure 350 comprising an upper beam, a bearing structure 360 comprising a lower beam, and a grate 370 arranged above the bearing structure 360. Moreover in this embodiment the wall 200 comprises straight heat exchanger pipes and the wall 200 is configured to support the bearing structure 360. The grate 370 comprises air nozzles 330. When the fluidized bed boiler 300 comprises sets of air nozzles, the grate 370 comprises a first set 330A of air nozzles and a second set 330B of air nozzles.

More specifically, in this embodiment, the first and second heat exchanger pipes 110, 120 of the wall 200 extend straight between the suspension structure 350 and the bearing structure 360; and the first direction Dir1 forms an angle of at most 5 degrees with an upward vertical direction Sz. As detailed above, these features improve the load-bearing capability of the wall 200.

Moreover, to utilize the load bearing capability of the wall, the wall 200 is fixed to the suspension structure 350 (e.g. the wall 200 is suspended from the suspension structure 350), the wall 200 supports the bearing structure 360 (e.g. the wall 200 is fixed to the bearing structure 360), and the bearing structure 360 supports the grate 370.

In an embodiment, a lower part of the furnace 310 has a downwards tapering shape, while an upper part of the furnace may have a substantially constant cross-section. The upper part may be defined e.g. such that the upper part is arranged above a division plane DP defined either by [A] a bend line BL of a side wall of the furnace 310 and a vertical normal or [B] bend lines BL of opposite side walls of the furnace 310. Reference is made to FIGS. 3c, 5a, and 5b.

Thus, in an embodiment, two opposite sides walls of the furnace 310 are each provided with a bend lines BL, as shown in FIGS. 3c and 5a. In FIGS. 3c and 5a, the bend lines BL extend in a direction Sx, which is perpendicular to the plane of the figure. Such bend lines BL of the side walls define a division plane DP. Thus, the bend lines BL are arranged on the division plane DP. The division plane DP is imaginary in the sense that it is not a material object, but a plane as defined in the field of geometry. Above the division plane DP, a primary part 311 of the furnace 310 is arranged. Below the division plane DP, a secondary part 312 of the furnace 310 is arranged. In an embodiment, only one side wall of the furnace 310 is provided with a bend line BL, which defines a division plane DP of which normal is vertical. If two bend lines BL define the division plane DP, a normal of the division plane DP need not be vertical.

Because of the at least one bend line BL, the secondary part 312 of the furnace 310 has a shape that tapers downwards. The primary part 311 of the furnace 310 may have a shape that has a constant cross-section in a vertical direction, the cross section having a normal in the vertical direction. The secondary part 312 extends downwards to the grate 370. The secondary part 312 extends upwards to the primary part 311. In FIGS. 3c and 5a the division plane DP forms an interface between the primary part 311 and the secondary part 312. The primary part 311 extends upwards from the secondary part 312.

Because of the downwards tapering shape of the secondary part 312 of the furnace 310, in the secondary part 312, the bed material flow is reasonably turbulent. Moreover, a turbulent flow has a tendency of eroding the surfaces. To prevent erosion of the heat exchanger pipes 110, 120, 130 within the secondary part 312 of the furnace 310, in an embodiment, within the secondary part 312 of the furnace, the heat exchanger pipes 110, 120, 130 of the wall 200 are covered by the refractory 230. More preferably, the refractory 230 is provided on the heat exchanger pipes 110, 120, 130 of the wall 200 throughout the secondary part 312 of the furnace 310. As a result, the first and second gaps 221, 222 of the wall 200 are arranged, in an embodiment, in the primary part 311 of the furnace 310.

In particular, in an embodiment, the first gap 221 is arranged in the primary part 311 of the furnace. In an embodiment, the first gap 221 is arranged above the division plane DP defined by the bend line BL or the bend lines BL of the side wall(s) of the furnace. In an embodiment, a second imaginary plane IP, of which normal is vertical, intersects the first gap 221 and is arranged at a higher vertical level than (i) the bend line BL of the side wall of the furnace 310, or (ii) one of the bend lines BL of the side walls of the furnace 310, or (iii) all of the bend lines BL of the side walls of the furnace 310 that define the secondary part 312 of the furnace 310. The second imaginary plane IP is imaginary in the sense that it is not a material object, but a plane as defined in the field of geometry. This applies also to the second gaps 222 mutatis mutandis.

Referring to FIGS. 5a to 5c, any embodiment of the wall 200 may be used as a side wall of the furnace 310 of the fluidized bed boiler 300. In such an embodiment, a first part P1 of the furnace 310 is arranged on a first side of the wall 200, and a second part P2 of the furnace 310 is arranged on a second, opposite side of the wall 200, whereby the second side S2 of the plane P is exposed to the second part P2 of the furnace 310. Thus, a first part P1 of the furnace 310 is arranged on a first side of the wall 200 and a second part P2 of the furnace 310 is arranged on a second, opposite side of the wall 200.

However, when the wall 200 is a side wall, the parts P1 and P2 of the furnace 310 function differently. In this case, most of the combustion takes place in the first part P1, while the second part P2 is mainly used for preventing the formation of the vortexes as discussed above. Thus, referring to FIG. 5a, in an embodiment, the first part P1 of the furnace 310 is provided with air nozzles 330 for fluidizing bed material in the first part P1 of the furnace 310. However, the second part P2 of the furnace 310 is free from air nozzles.

Moreover, to prevent bed material from escaping the furnace 310, the fluidized bed boiler 300 comprises a plate 250. At least part of the plate 250 is arranged on the second side S2 of the plane P. The plate 250 is fixed to the first fin 211 and configured to prevent bed material from escaping from the furnace 310.

FIGS. 7a and 7b show another embodiment of the wall 200. As shown in FIG. 7b, when viewed from above (see FIG. 7a for the cross-section VIIb), the wall 200 has a shape of a cross. Thus, the wall 200 comprises a first part 200a and a second part 200b. The first part 200a and the second part 200b are planar and arranged perpendicular to each other. The first part 200a comprises the heat exchanger pipes 110, 120, 130 and their portions 111, 112, 121, 122, 131, 132, as discussed above. The secondary portions 112, 122 of the pipes define the imaginable plane P, as discussed above and shown in FIG. 7b. Such a wall 200 may be used as a division wall, as detailed above. The effects of this wall 200 are two-fold. First, having perpendicular parts may improve supportive capacity of the wall 200. As detailed above, the wall 200 may support e.g. the grate 370. Second, having perpendicular parts may increase the area of heat transfer surfaces, and in this way improve the heat recovery. However, heat recovery can be improved also by using a lot of heat exchanger pipes, e.g. a wide wall 200.

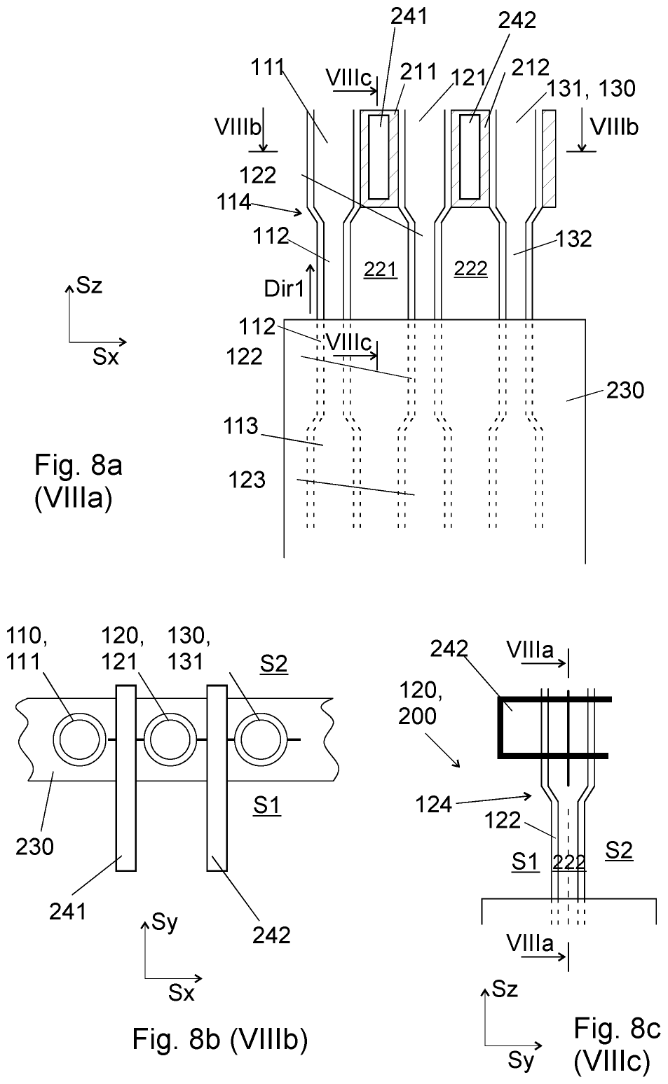

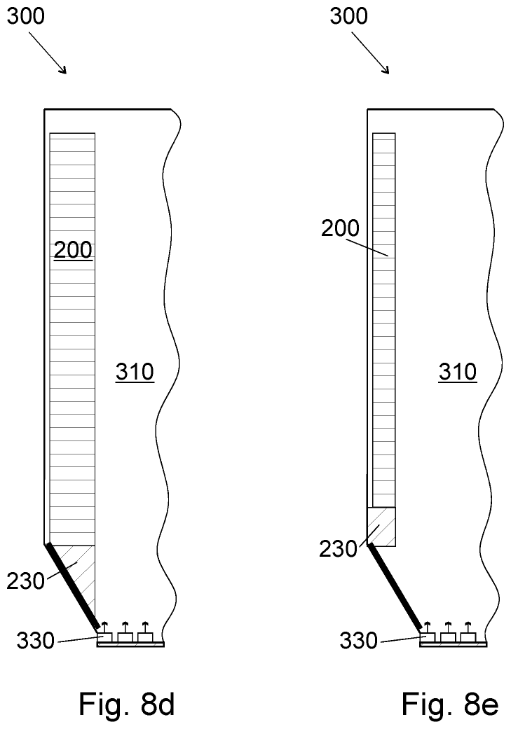

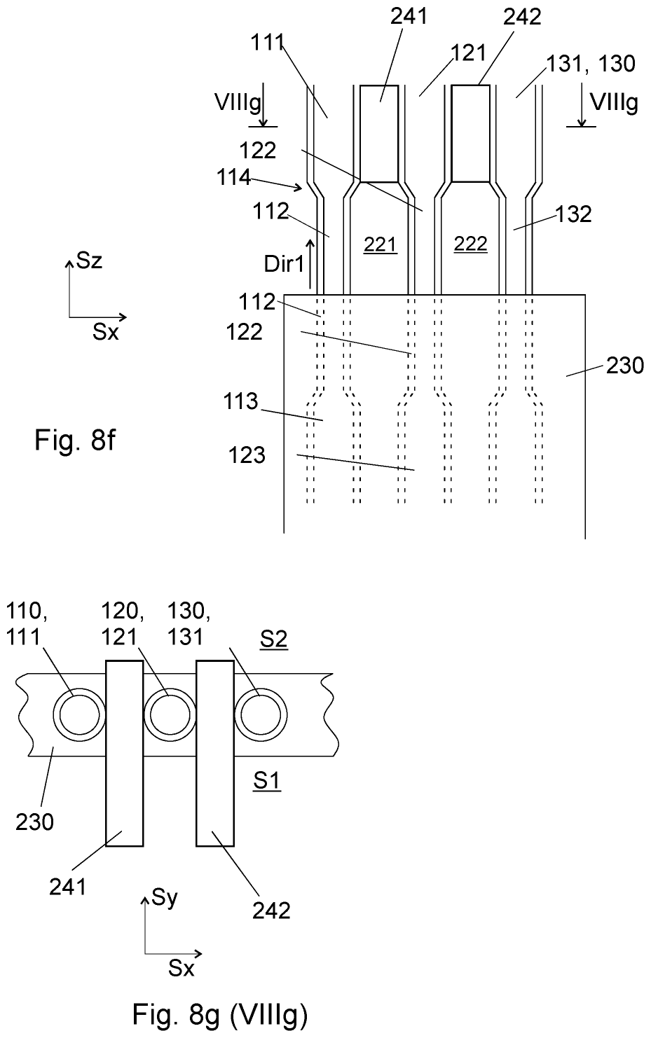

Referring to FIGS. 8a, 8b, 8c, 8f, and 8g, heat recovery can be improved also by using auxiliary heat transfer surfaces. FIGS. 8a to 8c show an embodiment of the wall 200. In this embodiment, the wall 200 comprises, in its upper part, auxiliary heat transfer surfaces 241, 242. For example, the first primary portion 111, the second primary portion 121, and the first fin 211, which form a part of the wall 200, may constitute a planar part. A first auxiliary heat transfer surface 241 may protrude from this planar part, as shown in FIGS. 8a to 8c. In a similar manner, a second auxiliary heat transfer surface 242 may protrude from the plane defined by the first primary portion 111, the second primary portion 121, and the first fin 211, as shown in FIGS. 8a to 8c. Such auxiliary heat transfer surfaces 241, 242 may be referred to as wings. As shown in FIG. 8c, the second auxiliary heat transfer surface 242 may comprise e.g. a heat transfer tube for recovering heat. This applies to other auxiliary heat transfer surfaces (e.g. 241), too. A purpose of the auxiliary heat transfer surfaces 241, 242 is to improve heat recovery.

Referring to FIGS. 8d and 8e, the walls with auxiliary heat transfer surfaces 241, 242 may be used e.g. near side walls of the furnace 310 to improve heat recovery.

As shown in FIGS. 8a to 8c, when the wall comprises auxiliary heat transfer surfaces 241, 242, such auxiliary heat transfer surfaces 241, 242 may penetrate the fins 211, 212. However, as indicated in FIGS. 8f and 8g, the auxiliary heat transfer surfaces 241, 242 may form the connectors that connect the primary parts 111, 121 of the pipes 110, 120. Thus, both a fin (211, 212) and an auxiliary heat transfer surface (241, 242) can be considered as a connector connecting the adjacent primary parts of the heat exchanger pipes.

Auxiliary heat transfer surfaces, if used at all, need not be arranged to connect each pair of adjacent heat exchanger pipes. Instead, as an example, the first primary part 111 may be connected to the second primary part 121 by an auxiliary heat transfer surface 241 as in FIG. 8g, even if the second primary part 121 is connected to the third primary part 131 by a fin as in FIG. 1c. A sufficient distance between auxiliary heat transfer surfaces 241, 242 may improve the heat transfer from bed material. A sufficient distance between auxiliary heat transfer surfaces 241, 242 may be achieved by using suitably many fin-connected heat exchanger pipes in between the auxiliary heat transfer surfaces 241, 242.

1-16. (canceled)

17. A wall for a fluidized bed boiler, the wall comprising:
a first heat exchanger pipe comprising a first primary portion and a first secondary portion,
a second heat exchanger pipe arranged in parallel with the first heat exchanger pipe, the second heat exchanger pipe comprising a second primary portion and a second secondary portion,
a first connector fixed to the first primary portion and to the second primary portion, and
a first gap between the first secondary portion and the second secondary portion,
wherein:
at least a part of the first secondary portion and at least a part of the second secondary portion extend straight, in parallel, and within an imaginable plane,
at least a part of the first gap penetrates through the plane such that particulate material is able to propagate through the first gap from a first side of the plane to the opposite second side of the plane, and
the wall further comprises a refractory arranged on at least one side of a part of the first secondary portion and a part of the second secondary portion such that a part of the first secondary portion extends from the refractory to a first direction, a part of the second secondary portion extends from the refractory to the first direction, and the first gap extends from the refractory to the first direction.
an outer diameter of the first secondary portion is less than or equal to an outer diameter of the first primary portion,
an outer diameter of the second secondary portion is less than or equal to an outer diameter of the secondary primary portion, and
the first direction forms an angle of at most 30 degrees with an upward vertical direction.

18. The wall of claim 17, further comprising:
a third heat exchanger pipe arranged in parallel with the second heat exchanger pipe, the third heat exchanger pipe comprising a third primary portion and a third secondary portion,
a second connector fixed to the second primary portion and to the third primary portion, and
a second gap between the second secondary portion and the third secondary portion,
wherein:
at least a part of the first secondary portion, at least a part of the second secondary portion, and at least a part of the third secondary portion extend straight, in parallel, and within the plane,
at least a part of the second gap penetrates through the plane such that particulate material is able to propagate through the first gap from the first side of the plane to the opposite second side of the plane and return through the second gap from the second side of the plane to the first side of the plane,
a part of the third secondary portion extends from the refractory to the first direction,
the second gap extends from the refractory to the first direction, and
the wall is configured such that particulate material is able to go round a side of the second secondary portion on the second side of the plane from the first gap to the second gap.

19. A fluidized bed boiler comprising:
a furnace,
an air nozzle for letting combustion air into the furnace,
a fuel inlet for letting fuel into the furnace, and
the wall of claim 17,
wherein the wall limits the furnace such that at least the first side of the plane is exposed to a part of the furnace.

20. The fluidized bed boiler of claim 19, further comprising a particle separator for separating particulate material from a stream received from the furnace for returning at least some of the separated particulate material back to the furnace.

21. The fluidized bed boiler of claim 19, wherein:
a first part of the furnace is arranged on a first side of the wall,
a second part of the furnace is arranged on a second, opposite side of the wall,
the first part of the furnace is provided with a first set of air nozzles for fluidizing bed material in the first part of the furnace, and
the second part of the furnace is provided with a second set of air nozzles for fluidizing bed material in the second part of the furnace.

22. The fluidized bed boiler of claim 19, further comprising:
a suspension structure comprising an upper beam,
a bearing structure comprising a lower beam, and
a grate arranged above the bearing structure,
wherein:
the grate comprises the first set of the air nozzles and the second set of air nozzles,
the wall is fixed to the suspension structure,
the wall supports the bearing structure,
the bearing structure supports the grate,
the first and second heat exchanger pipes of the wall extend straight between the suspension structure and the bearing structure, and
the first direction forms an angle of at most 5 degrees with an upward vertical direction.

23. The fluidized bed boiler of claim 19, wherein:
the furnace comprises a primary part of the furnace and a secondary part of the furnace,
the secondary part of the furnace has a shape that tapers downwards,
the primary part of the furnace is arranged above the secondary part of the furnace, and
the first gap is arranged within the primary part of the furnace.

24. The fluidized bed boiler of claim 23, wherein:
an imaginary division plane forms an interface between the primary part of the furnace and the secondary part of the furnace; and
a side wall of the furnace comprises a bend line arranged on the imaginary division plane, the imaginary division plane having either a vertical normal or two opposite side walls of the furnace comprise bend lines arranged on the imaginary division plane.

25. The wall of claim 17, wherein:
a body of the first secondary portion has a first profile shape extending in a longitudinal direction of the first secondary portion such that the first profile shape has a constant outer diameter throughout the length of the first secondary portion, the length of the first secondary portion being more than zero,
a body of the second secondary portion has a second profile shape extending in a longitudinal direction of the second secondary portion such that the second profile shape has a constant outer diameter throughout the length of the second secondary portion, the length of the second secondary portion being more than zero,
only a part of the first secondary portion is covered by the refractory whereby a part of the first secondary portion limits the first gap, and
only part of the second secondary portion is covered by the refractory whereby a part of the second secondary portion limits the first gap.

26. The wall of claim 17, wherein:
the first heat exchanger pipe comprises a first primary connecting portion connecting the first primary portion to the first secondary portion, and
the second heat exchanger pipe comprises a second primary connecting portion connecting the second primary portion to the second secondary portion.

27. The wall of claim 17, further comprising:
a first overlay arranged on at least a part of the first secondary portion and
a second overlay arranged on at least a part of the second secondary portion such that at least a part of the first overlay extends from the refractory to the first direction on the first secondary portion, laterally fully encircling at least a part of the first secondary portion, whereby at least a part of the first overlay limits the first gap, and
at least a part of the second overlay extends from the refractory to the first direction on the second secondary portion, laterally fully encircling at least a part of the second secondary portion, whereby at least a part of the second overlay limits the first gap,
wherein:
the first overlay comprises metal or ceramic, and
the second overlay comprises metal or ceramic.

28. The fluidized bed boiler of claim 19, further comprising:
a first overlay arranged on at least a part of the first secondary portion,
a second overlay arranged on at least a part of the second secondary portion such that at least a part of the first overlay extends from the refractory to the first direction on the first secondary portion, laterally fully encircling at least a part of the first secondary portion, whereby at least a part of the first overlay limits the first gap,
at least a part of the second overlay extends from the refractory to the first direction on the second secondary portion, laterally fully encircling at least a part of the second secondary portion, whereby at least a part of the second overlay limits the first gap,
wherein:
the first overlay comprises metal or ceramic, and
the second overlay comprises metal or ceramic.

29. The wall of claim 27, wherein:
a part of the first overlay is arranged laterally between a body of the first secondary portion and the refractory, and
a part of the second overlay is arranged laterally between a body of the second secondary portion and the refractory.

30. The wall of claim 27, wherein the first overlay comprises metal alloy and is an overlay welding, and the second overlay comprises metal alloy and is an overlay welding.

31. The wall of claim 27, wherein:
a thickness of the first overlay is 1 to 4 mm and
a thickness of the second overlay is 1 to 4 mm.

32. The wall of claim 17, wherein:
the first heat exchanger pipe comprises a first tertiary portion such that the first secondary portion is arranged between the first primary portion and the first tertiary portion,
an inner diameter of the first tertiary portion is greater than an inner diameter of the first secondary portion,
the second heat exchanger pipe comprises a second tertiary portion such that the second secondary portion is arranged between the second primary portion and the second tertiary portion, and
an inner diameter of the second tertiary portion is greater than an inner diameter of the second secondary portion.

33. The wall of claim 17, wherein:
the first secondary portion is not provided with a fin or fins, and
the second secondary portion is not provided with a fin or fins.

34. The fluidized bed boiler of claim 19, wherein:
a first part of the furnace is arranged on a first side of the wall,
a second part of the furnace is arranged on a second, opposite side of the wall, whereby the second side of the plane is exposed to the second part of the furnace,
the first part of the furnace is provided with air nozzles for fluidizing bed material in the first part of the furnace,
the second part of the furnace is free from air nozzles,
the fluidized bed boiler comprises a plate, of which at least a part is arranged on the second side of the plane, and
the plate is fixed to the first connector and configured to prevent bed material from escaping from the furnace.

35. The wall of the claim 17, wherein:
the first secondary portion is co-axial with the first primary portion, and
the second secondary portion is co-axial with the second primary portion.
